(19) United States
(12) Patent Application Publication
(10) Pub. No.: US 2007/0287022 A1
(43) Pub. Date: Dec. 13, 2007

(54) Intumescent paint coatings for inhibiting tin whisker growth and methods of making and using the same

(75) Inventors: Merrill M. Jackson, Tucson, AZ (US); David Humphrey, Tucson, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/493,684

(22) Filed: Jul. 25, 2006

Related U.S. Application Data
(60) Provisional application No. 60/811,609, filed on Jun. 7, 2006.

(51) Int. Cl. B05D 3/02

(52) U.S. Cl. 428/624; 427/393.3; 427/372.2

(57) ABSTRACT

An electrical component includes a conductive substrate, a tin layer formed on the substrate, and a coating of a foam formed on the tin layer to impede tin whisker growth, the coating comprising a foam having voids dispersed therethrough. A method for impeding tin whisker growth from a tin plating or finish formed over an electrical component includes covering the tin plating or finish with a coating of intumescent paint, and thereafter expanding the intumescent paint into a foam having voids dispersed therethrough.

### CROSS-REFERENCES TO RELATED APPLICATIONS

This application claims the benefit of U.S. Provisional Application No. 60/811,609, filed Jun. 7, 2006.

### TECHNICAL FIELD

The present invention relates to new or refurbished electronic assemblies or assembly components that may have a metal plating or finish, and more particularly to such assemblies or components having a tin plating or finish.

### BACKGROUND

Electronic assemblies or assembly components are often plated or finished with a metal. Printed wiring boards and electrical leads are just some examples of many components that typically have a metal finish. Perhaps the most abundant metal composition for a plating or a finish has been lead/tin (PbSn). However, laws and directives recently passed in several countries encourage or require the elimination of lead by those procuring, designing, building, or repairing electronic assemblies. The restriction of lead use has generated a transition by many piece part and board suppliers from PbSn surface finishes to lead-free finishes such as pure tin.

Tin finishes may be susceptible to spontaneous growth of single crystal structures known as tin whiskers. Tin whiskers are cylindrical, needle-like crystals that may grow either straight or kinked, and usually have a longitudinally striated surface. Growth rates for tin whiskers vary, although rates from 0.03 to 9 mm/yr have been reported. Interrelated factors including substrate materials, grain structure, plating chemistry, and plating thickness may influence growth rate. Although the whisker length depends on growth rate and sustained periods of growth, in experimental tests most measure between 0.5 and 5.0 mm although whiskers having a length of more than to 10 mm have been reported. The growth mechanisms for tin whiskers are largely unknown, although it is widely believed that whisker formation and growth are correlated with stresses such as localized compressive forces and environmental stresses on the tin plating or finish. Additional factors that may influence tin whisker growth include the materials constituting the substrate underlying the tin, and specifically a significant difference in the coefficients of thermal expansion between tin and the underlying substrate material since such a difference may stress the tin.

Tin whiskers may cause electrical failures ranging from performance degradation to short circuits. In some cases, the elongate structures have interfered with sensitive optical surfaces or the movement of micro-electromechanical systems (MEMS). Thus, tin whiskers are a potential reliability hazard.

One conventional attempt to impede tin whisker formation on tin plated or finished lead bodies is to overcoat the tin with a layer of tin/lead solder. The solder layer is thin and consequently incorporates less lead to the lead body than a conventional tin/lead coating that would be used in the absence of a tin plating or finish. While the thin solder layer is effective, it is not easily applied at the lead body region that interfaces with another electrical component without damaging the electrical component. For example, a quad flat pack is a fine-pitch surface mounting technology package that is rectangular or square with numerous <1 mm gull-wing shaped leads on all four sides. Each of the leads may include a tin finish. To impede tin whisker growth, the leads may be dipped in molten tin/lead solder. However, if molten solder touches the quad flat pack base surface, the heat may damage the component. Thus, there is a collar of pure tin on each lead body adjacent to the component body, which may produce tin whiskers. Since the numerous leads are very fine and closely-spaced, the tin whiskers may degrade the component performance or even cause adjacent leads to short circuit.

It is therefore desirable to provide materials and manufacturing procedures that mitigate the tendencies of pure tin and tin-containing solders, platings, and finishes to form tin whiskers. It is also desirable to provide such materials and methods that minimize the use of lead-containing compositions.

### BRIEF SUMMARY

The present invention provides an electrical component, comprising a conductive substrate, a tin layer formed on the substrate, and a coating of a foam formed on the tin layer to impede tin whisker growth, the coating comprising a foam having voids dispersed therethrough.

The present invention also provides a method for impeding tin whisker growth from a tin plating or finish formed over an electrical component. The tin plating or finish is first covered with a coating of intumescent paint. Thereafter, the intumescent paint is expanded into a foam having voids dispersed therethrough.

Other independent features and advantages of the preferred coatings and coating methods will become apparent from the following detailed description, taken in conjunction with the accompanying drawings which illustrate, by way of example, the principles of the invention.

### BRIEF DESCRIPTION OF THE DRAWINGS

FIG. 1 is a cross-sectional view of a quad flat pack having tin finished leads extending therefrom, the leads having an intumescent paint formed thereon according to an embodiment of the present invention;

FIG. 2 is a cross-sectional view of one of the leads illustrated in FIG. 1, including the tin finish and the intumescent paint formed thereon according to an embodiment of the present invention; and

FIG. 3 is a flow chart that illustrates an exemplary method for forming a coating of expanded intumescent paint on an electrical component according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

Electrical assemblies and components of the present invention have a tin plating or finish, and a coating formed from an expanded intumescent paint around the tin plating or finish. The paint is electrically nonconductive, and includes voids that are produced when the paint expands. Growth of tin whiskers through the expanded intumescent paint is inhibited due to the paint's discontinuous structure. More particularly, the voids remove lateral support for the tin whiskers, causing them to buckle and consequently either fail to exit the intumescent paint coating or fail to grow a substantial distance from the intumescent paint coating outer surface.

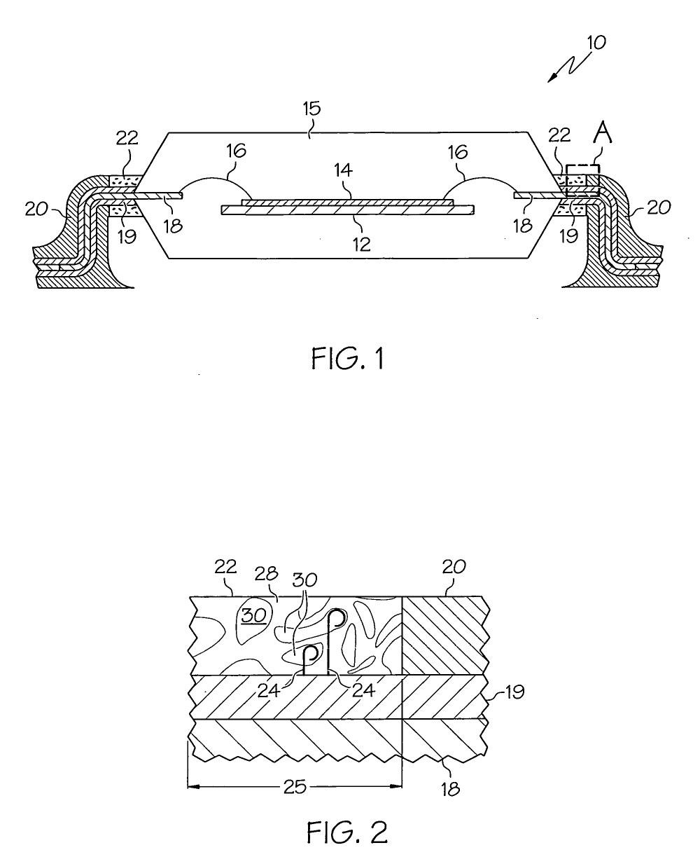

Turning now to FIG. 1, a cross-sectional view of a quad flat pack 10 having tin finished leads 18 extending therefrom. The quad flat pack 10 is just one exemplary, and the present invention is directed to any assembly or electrical component that may practically incorporate an intumescent paint formed around a tin plated or finished conductive element. A few examples of such components include a circuit card assembly, a wiring board, one or more components printed on a wiring board, and one or more conductive leads. The quad flat pack 10 illustrated in FIG. 1 includes a die-attach pad 12, which is formed from a conductive material such as a copper alloy, and a die 14 having an integrated circuit formed therein disposed on the pad 12. The pad 12 and die 14 are encapsulated in a mold compound 15 such as an epoxy material. A plurality of leads 18, i.e. two hundred and fifty or more leads, are coupled to contacts for respective circuit elements on the die 14 using a plurality of respective bond wires 16. A portion of each lead 18, along with its associated bond wire 16, is encapsulated in the mold compound 15.

Each of the leads 18 is a conductive material such as copper, and includes a tin finish. FIG. 2 is a cross-sectional view of the region “A” from FIG. 1, and depicts one representative lead 18 having a tin finish 19 formed around the lead 18. To impede tin whisker formation from the tin finish 19, a thin layer of tin/lead solder 20 is coated over most of the tin. However, the solder 20 is not easily applied at the lead body region that interfaces with the quad flat pack 10. For example, if molten solder touches the quad flat pack base surface, the heat may damage the overall quad flat pack 10. Thus, there is a collar 25 of pure tin on each lead body adjacent to the quad flat pack 10.

The collar 25 of pure tin is coated with a layer of intumescent paint 22 to impede tin whisker growth. The intumescent paint 22 is a foam that is expanded by thermally activating a paint layer. For example, most intumescent paints are a latex-based material, which forms a carbon-based char foam when thermally activated The foam includes a paint matrix 28 with a distribution of voids 30 that are products of the thermal expansion. A tin whisker 24 may penetrate the paint matrix 28 immediately adjacent to the tin finish 19. Further, a tin whisker 24 may continue to grow until it enters one of the voids 30 distributed throughout the foam. However, the tin whisker 24 buckles after it continues to grow and traverses a void 30. Buckling occurs as the tin whisker 24 collides with the paint matrix 28 after traversing the void 30, and has insufficient lateral support to re-penetrate the paint matrix 28. Instead, the whisker 24 buckles and is unable to continue penetrating the coating.

In order for the tin whisker 24 to buckle inside a void 30 without substantial resistance, the voids 30 preferably have a width that is at least ten times the tin whisker width. For example, if a tin whisker has a width of 3 microns, the void 30 should have a width of at least about 30 microns. Since tin whiskers typically have widths of up to about 5 microns, exemplary voids 30 have average widths of at least about 50 microns, although smaller voids may be selected if it is found that the tin whiskers are particularly thin growths. The tin whisker 24 becomes more bendable as it lengthens inside a void 30. If the tin whisker 24 is too short, the paint matrix 28, at the point where the tin whisker 24 entered the void 30, may provide sufficient lateral support to enable the tin whisker 24 to re-penetrate the paint matrix 28 without buckling. Since voids 30 are created by thermally activating the intumescent paint 22 and causing it to swell into a foam, void size can be manipulated by controlling the heating conditions, as will be subsequently described in detail.

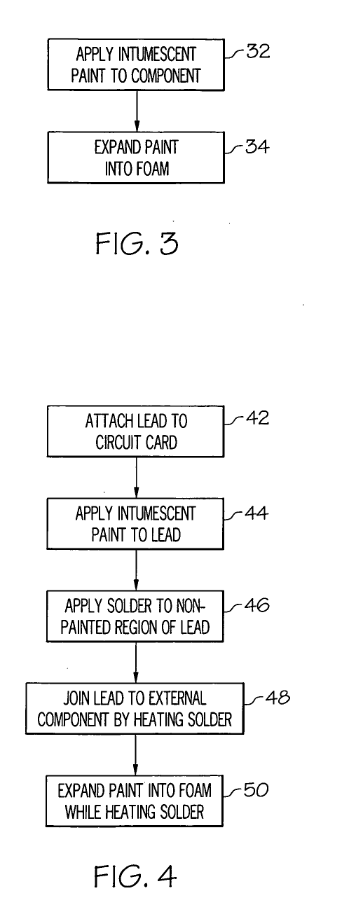

Turning now to FIG. 3, a flow diagram illustrates an exemplary method for forming a coating of expanded intumescent paint on an electrical component. The method is applicable generally to various electrical components that include a tin plating or finish. To start, an intumescent paint is applied to at least a portion of the tin plated or finished component as step 32. The paint may be applied by a variety of application methods, including screen printing, chemical deposition, and thermal or cold physical deposition methods, to name a few.

After applying the intumescent paint to selected component areas, the paint is activated and thereby expanded as step 34. In an exemplary method, the paint is expanded by subjecting the painted component to a temperature sufficient to expand the paint to a foam having predetermined void sizes. As previously discussed, the voids dispersed throughout the foam should be sufficiently large to allow any tin whiskers to grow until the whiskers, before traversing the entire void, have insufficient lateral support to re-enter the foam matrix. Since the voids become larger as the paint increases in temperature, heat application is preferably controlled to control the average pore size in the paint foam.

FIG. 4 is a flow diagram that illustrates a more specific exemplary method for forming a coating of expanded intumescent paint. This method is directed to the embodiment depicted in FIG. 1, which includes a lead 18 having a tin finish 19 is covered with an intumescent paint foam 22. Before the intumescent paint is applied, the assembly 10 includes the tin finished leads 18 bonded to circuit elements that are part of the encapsulated die. Any assembling that may be necessary to bring the assembly 10 to this point, including bonding the leads 18 to the die 14, may be performed as a preliminary step 42.

The intumescent paint 22 is applied to the collar region 25 of the tin finished leads 18 as step 44. As with the previous method, the paint may be applied by a variety of application methods, including screen printing, chemical deposition, and thermal or cold physical deposition methods, to name a few.

After applying the intumescent paint, solder is applied to the leads 18 as step 46. Exemplary solders include a lead/tin material or a tin/silver/copper (SAC) alloy, as tin whiskers do not tend to grow through such a solders. According to an exemplary embodiment, the solder is applied by dipping the leads into molten-phase solder, which then solidifies to form the solder coating 20.

Next, the soldered ends of the leads 18 are joined to an external component as step 48. Joining by a soldering technique requires sufficient heat to melt the solder. The heat generated by melting the solder is conducted along the lead to heat and thereby expand the intumescent paint 22 into a foam as step 50. In a preferred embodiment, the solder and intumescent paint are selected such that the melting temperature for the solder coincides with the expansion temperature for the intumescent paint. As previously discussed, the voids in the expanded foam preferably have a width that is at least ten times the tin whisker width since a tin whisker becomes more bendable as it lengthens inside a void. Since voids are created by thermally activating the intumescent paint, void size can be manipulated by controlling the heating conditions. More particularly, the temperature and the heating duration may be increased or decreased in order to respectively increase or decrease the average void size in the foam. The temperature and heating duration will vary depending on the paint material and its expansion properties.

The several methods and coating materials therefore provide electrical assemblies and components having a tin plating or finish, and a coating of expanded intumescent paint around the tin plating or finish. The voids in the foamed paint inhibit growth of any tin whiskers through the coating. While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An electrical component, comprising:
a conductive substrate;
a tin layer formed on the substrate; and
a coating of a foam formed on the tin layer to impede tin whisker growth, the coating comprising a foam having voids dispersed therethrough.

2. The electrical component according to claim 1, wherein the foam comprises expanded intumescent paint.

3. The electrical component according to claim 2, wherein the intumescent paint comprises a latex material.

4. The electrical component according to claim 1, wherein the voids have an average width of at least 30 microns.

5. The electrical component according to claim 1, wherein the voids have an average width of at least 50 microns.

6. The electrical component according to claim 1, wherein the conductive substrate is an electrical lead.

7. The electrical component according to claim 6, wherein the electrical component further comprises an electrical contact, and the electrical lead includes an end that is coupled to the electrical contact, the electrical lead including a painted region proximate to the lead end, the painted region having the coating of expanded intumescent paint thereon.

8. The electrical component according to claim 7, wherein the electrical lead further comprises a coating of solder adjacent to the painted region.

9. The electrical component according to claim 8, wherein the solder comprises a lead/tin alloy.

10. The electrical component according to claim 8, wherein the solder comprises a tin/silver/copper alloy.

11. A method for impeding tin whisker growth from a tin plating or finish formed over an electrical component, the method comprising:
covering the tin plating or finish with a coating of intumescent paint; and
expanding the intumescent paint into a foam having voids dispersed therethrough.

12. The method according to claim 11, wherein the step of expanding the intumescent paint comprises controlling the temperature and heating duration to produce voids having an average width that is sufficient to provide insufficient lateral support to allow any tin whiskers to grow through the foam.

13. The method according to claim 12, wherein the step of expanding the intumescent paint produces voids having an average width of at least 30 microns.

14. The method according to claim 12, wherein the step of expanding the intumescent paint produces voids having an average width of at least 50 microns.

15. The method according to claim 11, wherein the intumescent paint covers a tin plating or finish on an electrical lead.

16. The method according to claim 15, wherein the electrical component comprises an electrical contact, and the electrical lead includes an end that is coupled to the electrical contact, and
the step of covering the tin plating or finish produces a painted region on the lead proximate to the lead end, the painted region having the coating of expanded intumescent paint thereon.

17. The method according to claim 16, further comprising:
forming a coating of solder adjacent to the painted region; and
soldering the lead to an external component by heating and melting the coating of solder, and thereby expanding the intumescent paint into a foam.

18. The method according to claim 17, wherein the soldering step is performed using a solder comprising a lead/tin alloy.

19. The method according to claim 17, wherein the soldering step is performed using a solder comprising a tin/silver/copper alloy.

20. The method according to claim 11, wherein covering the tin plating or finish with a coating of intumescent paint comprises applying to the tin plating or finish a material that includes latex.
